(19) United States
(12) Patent Application Publication
(10) Pub. No.: US 2011/0168527 A1
(43) Pub. Date: Jul. 14, 2011

(54) MULTI-BELT CONVEYOR HAVING LINK BELTS

(76) Inventors: Francis B. Fatato, Exton, PA (US); Jeremy M. Bigler, Landisville, PA (US)

(21) Appl. No.: 12/987,894

(22) Filed: Jan. 10, 2011

Related U.S. Application Data
(60) Provisional application No. 61/293,465, filed on Jan. 8, 2010.

(51) Int. Cl. B65G 15/22; B65G 15/30

(52) U.S. Cl. 198/601; 198/846

(57) ABSTRACT

A conveyor system having a first conveyor intersecting a second conveyor is provided. A multi-belt transition conveyor assembly is provided at the intersection of the first and second conveyors. The transition conveyor assembly includes a plurality of parallel conveyors of varying lengths. Each belt includes a link belt and a support layer connected to the link belt. The support layer overhangs the link belt and may be comprised of a series of separate elements extending along the length of the link belt.

### PRIORITY CLAIM

This application claims priority to U.S. Provisional Patent Application no, 61/293,465 filed Jan. 8, 2010. The entire disclosure of the forgoing application is hereby incorporated by reference.

### FIELD OF THE INVENTION

The present invention relates to interlocking-link conveyor belts and has particular use in applications in which it is desirable to have a flat surface to convey products. The present invention has particular application in conveyor systems in which two conveyors intersect at an acute angle.

### BACKGROUND

Conveyor belts are commonly used in a variety material handling applications. Conveyor systems that include a large number of interconnected conveyors frequently intersect at an angle. Often, the intersections are similar to an on ramp for a highway, so that the belts intersect at an acute angle. Since the drive pulleys or rollers for the conveyor rotate about an axis perpendicular to the direction of travel for the belt, the drive axis cannot be skewed to abut the belt at the intersection. Therefore, a large gap would be formed at the intersection unless the conveyors are modified at the intersection. The known designs for such intersections use a network of narrow continuous belts that are parallel to one another. Although such a system reduces the gaps at the intersections, maintenance for such a system is labor intensive.

### SUMMARY OF THE PREFERRED EMBODIMENTS

Accordingly, the present invention provides a link belt for a conveyor system that overcomes one or more of the shortcomings of the known belts so that the belt can be used in a variety of applications.

According to one embodiment, a belt for a transition between intersecting conveyors is provided. The top surface of the belt may be connected to an underlying link belt by attaching one or more elements to the top surface of the belt. The belt links operate as a guide and a tensile member, while the top surface operates as a material handling surface. The multi-belt feeder comprises a plurality of link belts wherein each belt has elements attached to the top surface so that each individual belt can be readily separated and reconnected.

### BRIEF DESCRIPTION OF THE DRAWINGS

FIG. 1 is a perspective view of a portion of a conveyor system including an intersection of two conveyors.

FIG. 2 is an enlarged perspective view of a portion of the conveyor system illustrated in FIG. 1.

FIG. 3 is a side view of an interlocking-link conveyor of the conveyor system illustrated in FIG. 1 shown transporting a workpiece and engaged by a driving mechanism for the assembly.

FIG. 4 is a fragmentary side view partially in section, of the belt shown in FIG. 3.

FIG. 5 is a plan view of the belt shown in FIG. 4.

FIG. 6 is a top view of an individual link of the belt shown in FIG. 5.

FIG. 7 is a side view of the individual belt link shown in FIG. 6.

FIG. 8 is a perspective view of a portion of the belt illustrated in FIG. 3.

FIG. 9 is a top view of the individual link shown in FIG. 6, without an attached top layer element.

FIG. 10 is a side view of the individual belt link shown in FIG. 9.

FIG. 11 is a perspective view of a portion of the conveyor system of FIG. 1, with one of the belts removed.

### DETAILED DESCRIPTION OF THE PREFERRED EMBODIMENTS

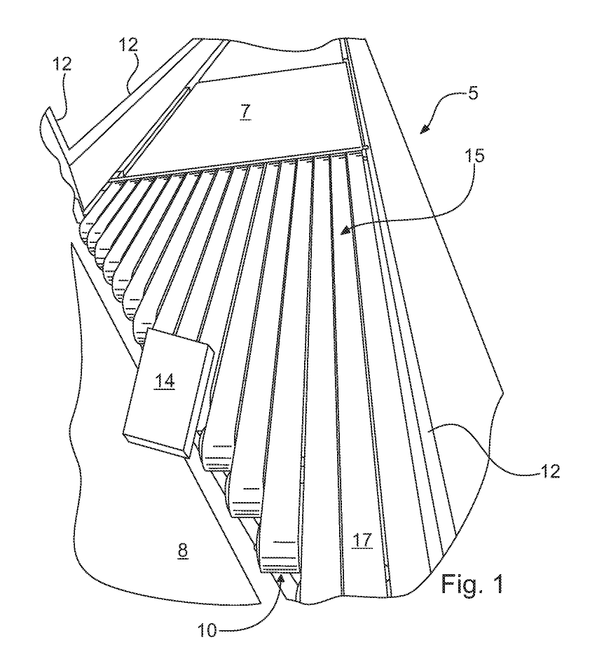

Referring now to the drawings in general and FIG. 1 specifically, a conveyor system is designated generally 5. The conveyor system 5 includes a first conveyor 7 and a second conveyor 8 for conveying items 14, such as work pieces, packages or other materials. The first conveyor 7 conveys items 14 toward the second conveyor 8. The first and second conveyors 7, 8 meet at an acute angle forming an intersection 10. In order to limit the gap between the first conveyor 7 and the second conveyor 8 at the intersection 10, the first conveyor includes a multi-belt transition conveyor assembly 15 at or adjacent the intersection 10.

Although the first and second conveyors 7, 8 may be any of a variety of conveyors, in the present instance, the conveyors are flat continuous conveyor belts, such as a 36″ wide flat conveyor belt for transporting various items on the top surface of the conveyor belts. Additionally, the first and second conveyors 7, 8 may include material handling elements on the top of the conveyors, such as cleats, lugs or push bars that may engage the items 14 to move the pieces along the conveyor system 5.

In the present instance, the conveyors 7, 8 are entrained about rollers or pulleys that support and drive the conveyor belts. The conveyors 7, 8 extend between side rails 12 that project upwardly to maintain the items 14 on the conveyors as the items are conveyed along the conveyor system.

As shown in FIGS. 1-3, the multi-belt transition 15 extends from the end of the first conveyor 7 to the intersection with the second conveyor 8. The transition is formed of a plurality of parallel narrow belts 17. In the illustrated embodiment, the transition 15 comprises a series of thirteen parallel belts 17 that comprise a combined width of approximately the same width as the first conveyor 7. Each separate belt 17 is entrained about a common shaft 13 at one end, and each belt is entrained about a separate roller at the intersection 10. Specifically, in the present instance, all of the transition belts 17 are entrained about a shaft at the end of the transition adjacent the first conveyor 7. The shaft includes a plurality of grooves spaced apart along the length of the shaft. Each separate belt rides in a separate groove to keep the belts aligned with one another along the width of the shaft. The belts 17 include support elements 40, the underside of which rides on the surface of the shaft as the shaft drives the belts 17.

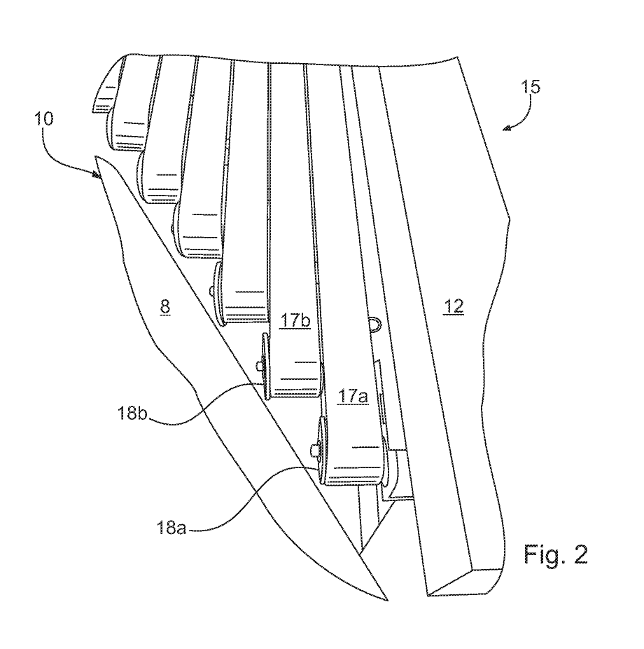

Although one end of each belt 17 is entrained about a common shaft, the opposite end of each belt 17 is separately entrained. For instance, as shown in FIG. 2, the transition 15 includes belt 17a at the right side of the transition, entrained about pulley 18a. Belt 17b is next to belt 17a, and is entrained about pulley 18b. Similarly, each of the thirteen belts 17 illustrated in FIG. 1-2 is entrained about one of thirteen separate rollers or pulleys.

As shown in FIG. 1, the belts 17 in the transition 15 are of varying length to form a step-like profile adjacent the first conveyor 7 in the intersection. For instance, as shown in FIG. 2, the right-most belt 17a is the longest belt in the transition conveyor assembly 15. Belt 17b next to belt 17a is slightly shorter than belt 17a. Each adjacent belt across the width is shorter than the next, so that the belt on the left edge of the transition, farthest away from the right-most belt 17a, is the shortest. The changing lengths of the belts are selected so that a line passing through a forward edge of each belt forms a line generally parallel to the side edge of the second conveyor 8, as can be seen in FIG. 1.

As can be seen from viewing FIGS. 1-2, increasing the number of belts 17 in the transition 15 decreases the width of the belts, which decreases the size of the gaps between the end of the transition 15 and the side edge of the second conveyor 8. However, increasing the number of belts 17 in the multi-belt transition 15 increases the complexity of the transition assembly. Accordingly, the number of belts in the transition 15 can vary to accommodate different width conveyors used in various systems. Further, the number of belts 17 in the transition can be varied for different applications depending on the size of the items 14 being conveyed, with larger items (relative to the width of the conveyor) requiring fewer belts in the transition, because the larger items can span the larger gaps created by using fewer belts in the transition.

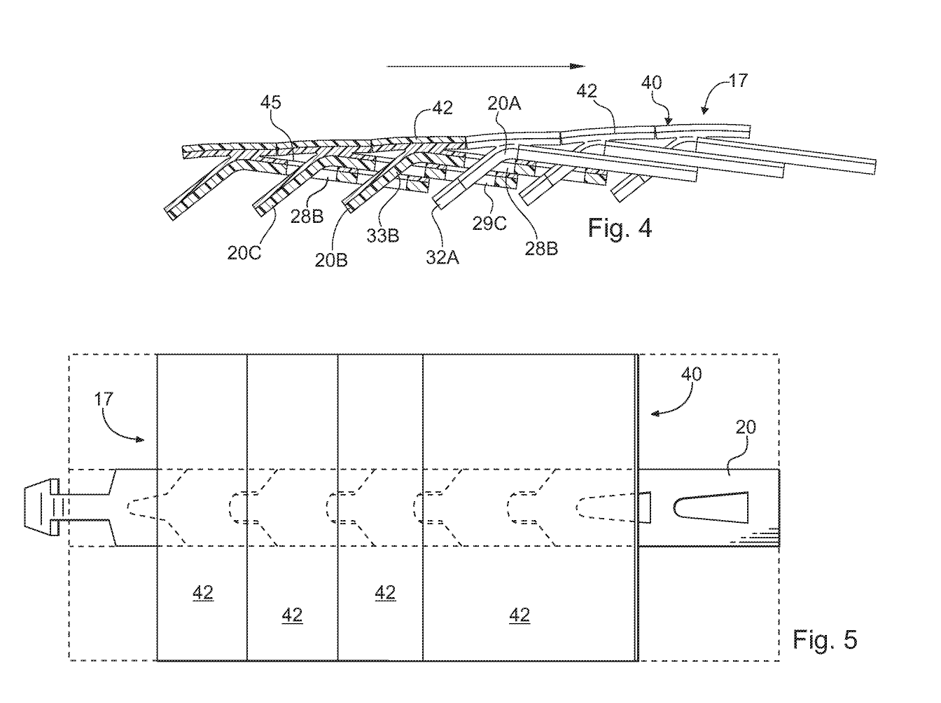

As discussed above, each belt 17 in the transition is generally the same, except for the length of the particular belt. Referring now to FIGS. 4-10, the details of the belt 17 are described in greater detail.

In the present instance the belt 17 is a link belt having an attached support surface 40. In the present instance, the support surface 40 provides a generally flat top surface for supporting the items 14 in the transition 15. In this way, when an item is placed on one of the belts 17 in the transition conveyor assembly, it is placed onto the support layer 40.

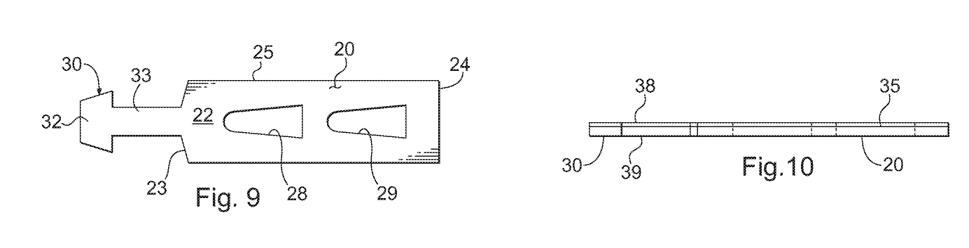

Referring now to FIGS. 4-10, the belt 17 comprises a series of interlocking belt links 20. One of the individual links 20 that comprises belt 17 is illustrated in FIGS. 9 and 10. Each belt link 20 has a body portion 22 and a fastener 30 connected to the body portion. In the present instance, the thickness of the belt link 20 between the top surface 38 and the bottom surface 39 is substantially uniform throughout the entire link.

A bonding material may be permanently bonded to the top surface of each belt link 20. The bonding material forms a bonding surface 35 that is coextensive with the top surface of the belt link 20. In the present instance, the bonding surface 35 is approximately 1 mm or less, but depending on the application, the bonding surface may be thicker than 1 mm.

The body portion 22 of the belt link 20 is generally rectangular, having two edges 25 extending longitudinally between a leading end 24 and a trailing end 23, both of which extend transversely between the two edges. Adjacent leading end 24 a leading aperture 29 extends through the thickness of body portion 22. Longitudinally spaced from the leading aperture 29 adjacent the trailing end 23, a trailing aperture 28 extends through the thickness of body portion 22.

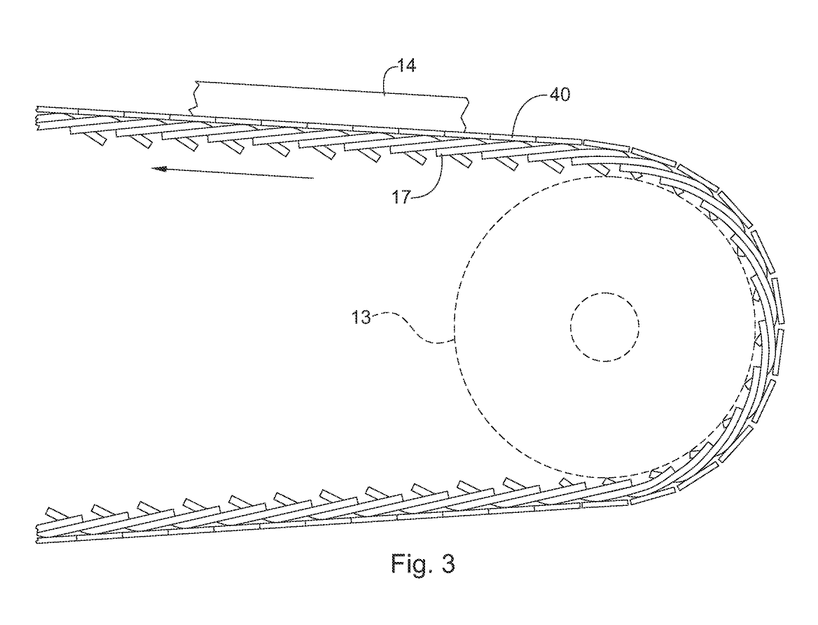

The leading end 24 corresponds to the direction in which the assembly 10 travels as shown by the arrow in FIG. 3. However, the direction in which the assembly 10 travels can be reversed so that the leading end 24 does not lead the trailing end 23 with respect to the actual travel of the assembly.

The fastener 30 integrally connects the body portion 22, and comprises a fastening tab 32 and a constricted neck 33. The neck extends longitudinally, with one end connected to the fastening tab 32, and the other end connected to the trailing end 23 of body 22. The length of the neck 33 between the trailing end 23 and the fastening tab 32 is sufficiently long to allow the fastening tab 32 to extend through the apertures in two belt links 20 as will be further discussed below.

The fastening tab 32 is generally trapezoidal shaped, having two parallel ends that are transverse the neck 33. The fastening tab 32 is substantially wider than the neck 33, being widest at the point where it intersects the neck, and tapering as it extends away from the neck.

The belt links 20 are connected by passing the link fasteners through the apertures in adjacent belt links. To ensure that the belt links can properly connect, the apertures are configured and dimensioned with reference to the fastening tab and the neck.

In the present instance, the apertures through body 22 are non-circular. Both apertures 28 and 29 are longitudinally elongated so that their length 26 is greater than their width. To ensure that fastening tab 32 can pass through the apertures, the length of the apertures is greater than the greatest width of the fastening tab 32.

The width of apertures 28 and 29 is not constant. Instead, the apertures widen as they extend toward leading end 24. To provide proper connection between the belt links 20, the apertures are narrower than the fastening tab width so that the fastening tab 32 cannot pass back through the apertures once the belt links are connected. However, the apertures are wider than the neck 33 to allow the neck to extend through the apertures while the belt links are connected, as will be discussed below.

The belt links 20 are made of a material of sufficient tensile strength to convey the portion of the weight being supported by one of the individual belts 17 in the transition 15. In the present embodiment, the belt links 20 are made of a thermoset urethane that is reinforced with a polyester fabric.

Because the belt links have sufficient tensile strength to convey the weight of the items 14, the tensile strength of the material used to make the support layer 40 can be a secondary consideration. As is discussed below in greater detail, in the present instance, the support layer 40 is formed as a separate element that is attached to the surface of the links 20. Referring to FIGS. 4-5, in one example, the support layer 40 is a thin layer of material similar to the material from which the belt links are formed. For instance, the support layer may be formed of polyester fabric reinforced thermoset urethane that is less than the thickness of the material from which the belt links 20 are formed.

As previously stated, the transition conveyor assembly 15 comprises a plurality of interlocking-link belt 17 having a support layer 40, which is comprised of a plurality of belt links 20 that have been described above. The following discussion describes the interconnections between the belt links 20 that form the belt 17.

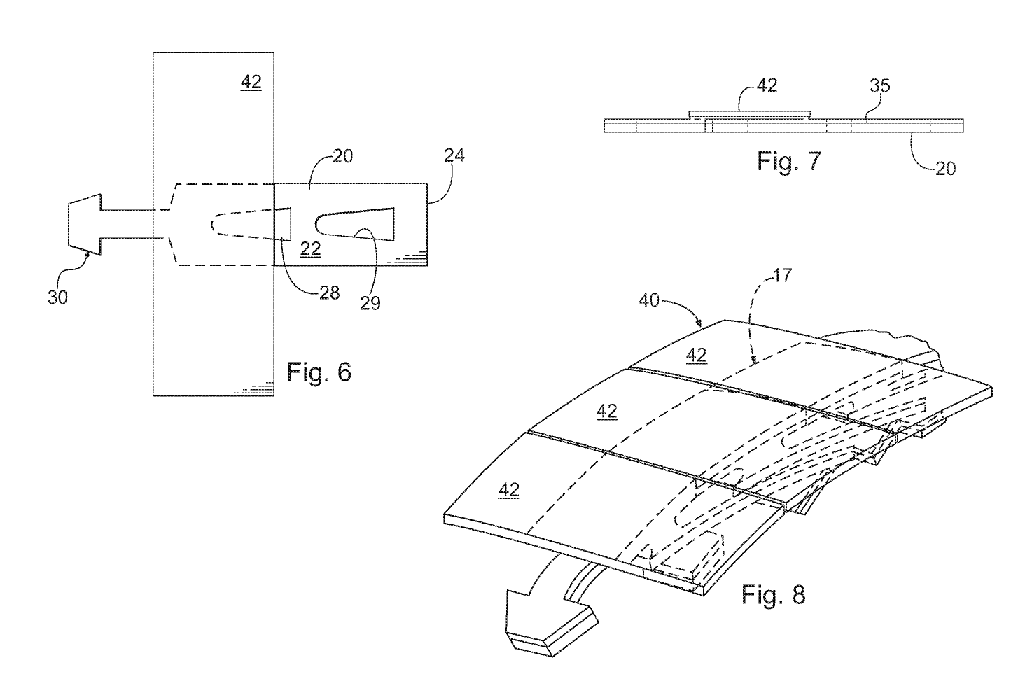

As shown in FIGS. 5 and 6, a series of belt links 20 are arranged in a superimposed successive overlapping relation to form the belt 17 having a bonding surface 35. The bottom surface 39 of each belt link overlaps the top surface 38 of an adjoining belt link, so that the thickness of the belt 17 is at least twice the thickness of an individual belt link 20.

FIGS. 4 and 8 illustrate a portion of the transition assembly 15 showing how the bonding layers 35 of the belt links combine to form a bonding surface when the belt links are interconnected. Included in these views is the connection between a belt link 20C, and the two preceding belt links, 20B, and 20A. In this connection, the fastening tab 32A of belt link 20A passes sideways through apertures in the two trailing belt links. It first passes through the trailing aperture 28B of the adjacent trailing belt link 20B and then passes through the leading aperture 29C of the next trailing belt link 20C.

The term preceding is used with respect to the direction the assembly travels, as shown in by the arrows in FIG. 3. Because the direction of travel can be reversed, the preceding belt links can be succeeding with respect to the actual travel of the assembly 15.

After passing through the aperture in belt link 20C, the belt link fastening tab 32A is twisted to bear against the bottom surface of belt link 20C. When connected in this way, the top surface of belt link 20A is the top side of belt 17, and the bottom surface of belt link 20C is the bottom side of belt 17.

The belt 17 is produced as follows. The belt links 20 are made of a material having sufficient tensile strength to withstand the tension in the belt as the belt is driven during use. The links may be formed of any of a variety of high tensile strength materials. According to one example, the belt 17 links include at least one layer of reinforcing material, such as woven polyester sheet. The reinforcing material is impregnated with a binding material to form a composite material. The binding material is liquified and deposited onto the reinforcing material while liquid. The composite material may include a plurality of layers of reinforcing material and the binding material may be a thermoset urethane.

A bonding material is deposited on the composite material, preferably while the binding material is wet. In other words, preferably the bonding material is deposited on the composite material before the composite material is cured or dried. The bonding material may be sprayed on, poured on or the composite material may be partially submerged in a bath of bonding material. The bonding material may be a chemical adhesive, such as an epoxy. However, preferably the bonding material is a film of thermoplastic urethane that is approximately coextensive with the upper surface of the composite material. Since the binding material of the composite material is wet when the film is placed on the composite material, the film adheres to the composite material.

After the bonding material is deposited on the composite material, the combination is cured. During the curing process the layer of bonding material permanently bonds to the composite material.

Ordinarily the cured material is at least several times wider that the width of the belt links 20. The cured material is therefore cut into a plurality of elongated strips approximately as wide as the width of a belt link 20. The belt links are then cut-out from the strips of cured material. In the present instance, the belt links are formed by punching, which also simultaneously punches the rearward and forward apertures in the belt links.

Formed in this way, the belt links 20 have an integral bonding surface approximately 1 mm thick forming the top surface 38 of the belt link. The bonding surface is coextensive with the substrate material forming the belt link 20 which in the present instance is polyester reinforced thermoset urethane.

The belt links 20 are assembled to form a continuous interlocking link belt 17. The belt links 20 are connected to one another as detailed above and shown in FIGS. 4 and 5. Preferably, the assembled belt is then trimmed by cutting the edges of the belt to form beveled edges.

Referring to FIGS. 4 and 5, the details of the support layer 40 will be described in greater detail. The support layer 40 may be formed of one or more generally flat elements that extend along the length of the link belt 17. The support layer 40 extends transverse the length of the interconnected belt links. More specifically, the support layer 40 extends outwardly having a width substantially greater than the width of the belt links. For instance, the support layer 40 may be at least twice as wide as the width of the belt links 20, and in the present instance, the support layer may be three times the width of the belt links or wider. In this way, the support layer 40 overlies the belt links so that the width of the support layer projects transversely away from each side of the link belt. Accordingly, each side edge of the support layer is laterally spaced apart from the belt links so that the side edges do not overlie the underlying belt links.

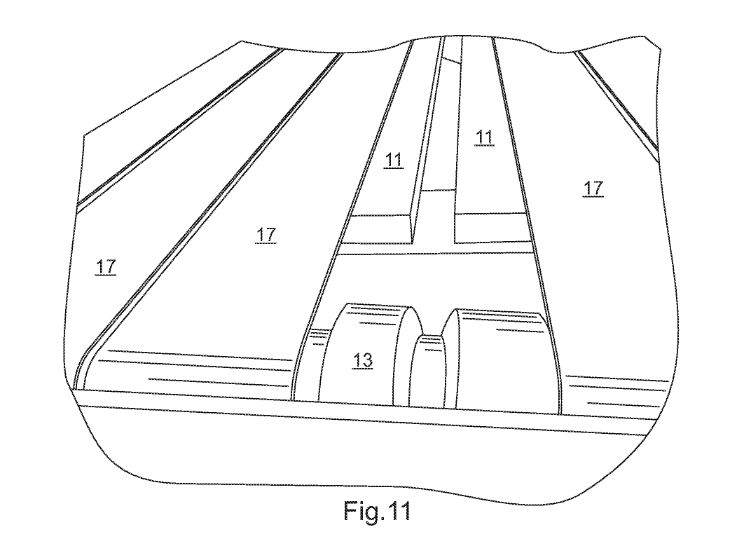

As discussed above, support layer 40 does not need to carry the tensile forces of the belt 17. Additionally, referring to FIG. 11, the support layers 40 are supported by a series of slider bars 11 forming a slider bed. Specifically, the slider bars form elongated planar support elements having sufficient rigidity to carry the load of the items being conveyed by the transition conveyor assembly 15. In the present instance, the slider bars are formed of metal, such as steel, however, the slider bars can be formed of any of a variety of low friction metal or plastic materials. For instance, rather than steel, the slider bars may be formed of ultra high molecular weight (UHWM) plastic.

The slider bed includes a plurality of parallel spaced apart slider bars 11. As shown in FIG. 11, the slider bars 11 are spaced apart from one another to form a gap. The belt 17 rides in the gap so that the belt does not ride on the slider bars; instead, the belt rides between adjacent slider bars with the support layers riding on top of the slider bars.

In embodiment in FIGS. 3-10, the support layer 40 is formed of a series of substantially flat elements positioned end to end along the length of the belt to form a generally continuous top layer for the conveyor assembly 15. As discussed previously, the support elements 42 may be formed of polyester fabric reinforced thermoset urethane similar to the material used to form the links. Like the belt link material, the material for the support elements may include a layer of thermoplastic urethane. In this way, the bottom surface of each support element may have a layer of thermoplastic urethane that can be used to thermally weld the support element to the link belt 17. Further, it may be desirable to have a high friction top surface. Therefore, the top surface of the support elements may also be a layer of thermoplastic urethane. In either instance, in the present instance, the support element is thinner than the belt links 20, having a thickness of approximately 2 mm. However, in certain applications it may be desirable to utilize a top element having a greater thickness.

Each support element 42 may be elongated so that each element overlies the exposed upper surface of numerous belt links 20. However, in the present instance, the support elements overlie portions of two belt links and each support element is attached to a single belt link. Specifically, as shown in FIG. 4, each support element is attached to the protrusion formed at the intersection between two adjacent links.

As shown in FIG. 5, the support elements 42 may overlie one or more links. Specifically, as shown in FIG. 5, each support element 42 at the right side of the assembly overlies the length of two belt links. In other words, a support element is connected to every other belt link, and the support element 42 is sufficiently long to overlie two link lengths so that the trailing edge of the support element is adjacent the leading edge of the subsequent support element. Similarly, the support elements 42 at the left side of the assembly in FIG. 5 are configured to overlie a single belt link length. In such a configuration a support element 42 is connected with each belt link, and is sufficiently long to overlie the length of a belt link. In this way, the trailing edge of the support element 42 is adjacent to the leading edge of the support element on the support element 42 on the subsequent belt link.

The support elements 42 may be individually formed and attached to the belt links before or after the belt links are combined to form the link belt 17. For instance, referring to FIG. 6, a support element 42 may be attached to the top surface of the belt link 20. When the belt links are subsequently connected to form a length of belt, the support elements will be aligned so that the support elements overlie the length of the belt.

In the present instance, the support elements are attached to the belt 17 after the belt is formed, but before the ends of the belt are connected to form a continuous loop. More specifically, as described further below, the support elements are formed from an elongated section of the support layer that is attached to the top surface of the belt and then severed to form the separate support elements.

A number of belt links are assembled together to form a length of belt, without connecting the ends to form a continuous belt. An elongated strip of support layer material is adhered to the top of the length of assembled belt links. In the present instance, the length of the support layer material is sufficient to overlie the entire length of assembled belt links.

The support layer material may be adhered to the top of the belt by various methods, such as by mechanical fastener, or chemical adhesive, such as epoxy. However, as described previously, in the present embodiment, the support layer is thermally welded to the belt links. To attach the support layer 40, the support layer is placed on top of the belt. Heat is then applied to the support layer and the bonding surface to fuse the top layer and bonding surface together. In other words, heat is applied so that the thin layer of urethane on the top surface of the belt melts together with the thin layer of urethane on the bottom surface of the support layer 40.

Although the entire length of the belt 17 and the top layer 40 may be heated to weld the entire length of the top layer, in the present instance, the length of the top layer is progressively welded to the belt. A portion of the length of link belt is advanced through an oven along with a corresponding portion of the length of top layer material. The link belt and top layer enter the oven at one end as separate items, and are discharged from the oven at a second end after the link belt and top layer are heated in the oven to weld the items together. As the welded belt assembly is pulled through the discharge end of the oven, a trailing portion of the top layer and link belt enter the oven and are welded together. In this way the top layer is progressively welded to the length of the belt.

After the top layer 40 is attached to the link belt, the ends of the link belt are attached to form a continuous belt. In some applications it may be desirable to utilize the belt with a continuous unitary top layer. However, it may be desirable to separate the top layer into a series of support elements. In this way, the belt can be disconnected at various positions along the length of the belt without having to sever the belt at that time.

In the embodiment in which the top layer is separated into a series of support elements, the top layer may be formed as follows. After the top layer is adhered to the link belt, the top layer is severed at a plurality of points along the length of the belt. More specifically, referring to FIGS. 4 and 8, the support layer 40 forms a bridge that extends from the front edge of the body of a belt link to the front edge of the body of the preceding belt link. The top layer is attached to the belt links at the front edge of each link, however, there is a gap 45 between the top edge of the belt and the top surface in between the attachment points. At a point where there is a gap 45, the top layer is cut across the width and thickness of the top layer. Further, by cutting the top layer at each of the gaps, the top layer is cut into a series of separate elements, with each element being attached to a single belt link. In this way, any belt link can be detached from an adjacent belt link and replaced as necessary.

In the above embodiment the belt is a link belt with links connected by tabs. However, the present invention is broad enough to include other types of belts. For instance, other types of link belts can be used, such as a riveted link belt in which the overlapping links are riveted to each other.

In addition, although the top layer has been described as a thin layer of reinforced thermoset urethane, the assembly is not limited to the particular type of top layer. For instance, the top layer may be relatively thick or it may be formed from various materials, such as fiber reinforced, metal reinforced or foamed thermoplastic urethane. Additionally, although the bonding surface 35 and support layer 40 include a thermoplastic urethane, the elements can be formed from other materials. However, it is desirable that the materials be selected to ensure a consistent secure bond between the belt and the top layer. Preferably, the bond is provided by thermally bonding the belt 17 and the support layer 40 as described above, so the materials should be selected to provide a consistent secure thermal bond. In other instances however, it may be desirable to use a chemical adhesive as a primary or secondary bond between the support layer and the belt. If a chemical adhesive is used as a primary bond, it is possible to eliminate the thermal bond between the two layers. If the chemical adhesive is used as a secondary bond, preferably the chemical adhesive provides additional support to the thermal bond. If a chemical adhesive is used as a primary or secondary bond, the bonding surface and top layer should be formed of materials that can be securely connected by the chemical adhesive.

In the foregoing description, the support layer 40 has been described as having a thermoplastic urethane lower surface so that the support layer can be thermally bonded to the top surface of the belt links 20. In some instances, it may be desirable to configure the lower surface of the support layer so that the portion of the bottom surface that does not contact the belt links is free from urethane. For instance, the lower surface of the support layer 40 may have a stripe of urethane down the middle that is approximately as wide as the width of the belt links. The rest of the lower surface of the support layer 40 may have a lower coefficient of friction that the strip of urethane material. Alternatively, after the support layer 40 is connected to the belt links, the exposed lower surface of the support layer that does not overlie the belt links may be modified to have a lower coefficient of friction than the urethane layer. For instance, after the support layer is attached to the belt, the exposed urethane layer may be removed, such as by abrasion or the exposed lower surface may be overlaid with a low friction material, such as a fabric scrim to reduce the coefficient of friction.

As described above, support layer 40 may be formed of a single element or a plurality of separate elements. An embodiment in which the support layer is formed as a single layer 40 is illustrated in FIG. 11, which has been found to be preferred for material handling applications. Specifically, in a preferred embodiment, the support layer comprises a substantially continuous unitary element overlying at least 10 links of the link belt, and in an exemplary embodiment the support layer is a continuous unitary element overlying substantially the entire length of the link belt 17.

The support layer 40 may be formed of a variety of materials as described above, however, in the embodiment illustrated in FIG. 11, the support layer is formed of a material that can be affixed to the link belt by thermal bonding as described above. Additionally, the support layer may be formed of a generally homogeneous material having greater flexibility than the links of the link belt 17. In an exemplary embodiment, the support layer is formed of a thermoplastic material, including thermoplastic urethane or polyurethane or other plastic material(s). Furthermore, the support element may be formed of a material having significantly less tensile strength that the links of the link belt. For instance, the support element may be formed so that the link belts have at least ten times the tensile strength of the support element. Further still, the link belts may have at least 100 times the tensile strength of the support element, and in an exemplary embodiment, the link belts have at least 500 times the tensile strength of the support element.

In addition to having less tensile strength than the link belt, the support element may be formed of a material having greater elongation to failure than the links of the link belt. For instance, the support element may have up to 550% elongation, and in one example is between 400-550%. In contrast, the links of the link belt have less than 400% elongation and may have less than 100% elongation. In one example the links have less than 50% elongation. In this way, during use, the support layer more readily elongates when subjected to an axial load than the link belt. Furthermore, the greater flexibility of the support layer may allow the support layer to elongate in response to inter-laminar shear forces between the support layer and the link belt as the assembly is driven around the pulleys.

As described above, one exemplary manner for affixing the support layer to the link belt is by thermally bonding the support layer to the link belt. Additionally, in applications in which the support layer is an elongated member extending over a plurality of links, it may be desirable to include a supplemental connection mechanism. For instance, in an application in which the support layer is a single continuous element overlying substantially the entire length of the link belt, it may be desirable to incorporate a first rivet mechanically fastening the lead end of the support element to the link belt and a second rivet mechanically fastening the trailing end of the support element to the link belt. Similarly, if the support layer is formed of a plurality of elements rivets may be incorporated to mechanically fasten the end of each support element to the link belt in addition to connecting the support element to the link belt via an inter-laminar connection, such as thermal bonding or chemical bonding, such as adhesive or epoxy.

Configured as described above, some of the benefits of the improved system include a multi-belt transition between conveyors that allows for reduced maintenance of the transition. Each of the transition belts supports a portion of the weight of the items 14 being conveyed, and each belt can be separately replaced without dismantling the entire conveyor or transition assembly. Additionally, although the multiple belts may be tensioned together by a single tensioner, the tension of each belt may be altered separately by adding or removing links. Specifically, the tension in one of the belts 17 may be reduced by adding a link to the length of the individual belt. Doing so affects the tension in the particular belt, without affecting the tension in the other belts 17 in the transition 15. Similarly, the tension in one of the belts can be increased independent of the tension in the remaining belts in the transition 15, by removing a link from the belt.

The terms and expressions which have been employed are used as terms of description and not of limitation. For instance, as described above, the bonding layer for the link belt is created by forming a the bonding layer on the material used to create each link. Alternatively, the bonding layer may be applied to each belt link after each link is formed, such as by coating the links with thermoplastic urethane or another suitable material. Yet another alternative is to apply the bonding material to the surface of the link belt after the links are connected together. There is no intention in the use of such terms and expressions of excluding any equivalents of the features shown and described or portions thereof. It is recognized, however, that various modifications are possible within the scope of the invention as claimed.

That which is claimed is:

1. A conveyor assembly, comprising:
a first conveyor for conveying items on a top surface of the first conveyor;
a second conveyor for receiving the items from the first conveyor; wherein the second conveyor is disposed at an acute angle relative to the first conveyor, wherein an intersection is formed between the first and second conveyors; and
a transition conveyor assembly at the intersection of the first and second conveyors, wherein the transition conveyor has a direction of travel parallel to the direction of travel of the first conveyor, and wherein the transition conveyor comprises a plurality of parallel belts forming an upper conveyor surface between the first conveyor and the second conveyor; wherein the belts of the transition conveyor are of varying lengths, and belts of the transition conveyor comprise:
an interlocking link belt comprising a series of belt links arranged in superimposed successive overlapping relation, said belt having a thickness between its top and bottom sides corresponding to the thickness of at least two belt links, each of said belt links having:
a body portion with a lateral width, a longitudinal length, at least one aperture, and an integral fastener at the leading end of said body portion and longitudinally-aligned with said aperture, said fastener comprising:
a laterally constricted fastener neck portion; and
a fastening tab connected to said body portion through said neck portion;
said belt links of said series being secured together in overlapping relation to form a belt by the neck of said fastener extending from one of said sides of the belt through said aperture in the preceding belt link, said fastening tab engaging the other of said sides of said belt at the preceding belt link to secure the belt links together; and
an elongated top layer overlying the link belt to provide a generally flat top surface for supporting items being conveyed from the first conveyor to the second conveyor, wherein the top layer is fixedly attached to the link belt and has a width that projects laterally away from the link belt to form an overhanging support surface.

2. The conveyor system of claim 1 wherein the link belts of the transition conveyor assembly withstand the tensile load of the belts in the transition conveyor assembly.

3. The conveyor system of claim 2 wherein the top layer supports items being conveyed without maintaining substantially any of the tensile load of the belts in the transition conveyor assembly.

4. The conveyor assembly of claim 1 wherein one end of the belts of the transition conveyor assembly is entrained about a common shaft.

5. The conveyor assembly of claim 4 wherein a tensioner tensions the common shaft to adjust the tension in each belt of the transition conveyor assembly.

6. The conveyor assembly of claim 4 wherein a second end of each belt of the transition conveyor assembly is entrained about a separate rotary element so that the belts in the transition conveyor assembly are entrained about rotary elements that are separate from the adjacent belt in the transition conveyor assembly.

7. The conveyor assembly of claim 4 wherein the common shaft comprises a plurality of spaced apart grooves along the length of the shaft, and a separate link belt of the transition conveyor assembly rides in one of the grooves to guide the separate link belts as the shaft rotates.

8. The conveyor assembly of claim 7 wherein the grooves maintain the link belts in a spaced apart generally parallel orientation across the width of the transition conveyor assembly.

9. The conveyor assembly of claim 1 wherein the support elements are thermally bonded to the belt links.

10. The conveyor assembly of claim 9 wherein each support element has a width at least two times the width of the belt links.

11. The conveyor assembly of claim 10 wherein each support element has a width at least three times the width of the belt links.

12. The conveyor assembly of claim 10 wherein each support element has greater elongation than the belt links of the belt to which the support element is connected.

13. The conveyor assembly of claim 1 wherein the top layer overlies substantially the entire length of the link belt.

14. A conveyor assembly, comprising:
a first conveyor for conveying items on a top surface of the first conveyor;
a second conveyor for receiving the items from the first conveyor; wherein the second conveyor is disposed at an acute angle relative to the first conveyor, wherein an intersection is formed between the first and second conveyors; and
a transition conveyor assembly at the intersection of the first and second conveyors, wherein the transition conveyor comprises a plurality of parallel belts having different lengths from one another and a direction of travel parallel to the direction of travel of the first conveyor;
wherein the conveyor belts of the transition conveyor assembly comprise:
an interlocking link belt comprising a series of belt links arranged in superimposed successive overlapping relation, and
an elongated top layer overlying the link belt to provide a generally flat top surface for supporting items being conveyed from the first conveyor to the second conveyor, wherein the top layer is fixedly attached to the link belt and has a width that projects laterally away from the link belt to form an overhanging support surface.

15. The assembly of claim 14 wherein the top layer is thermally bonded to the link belt.

16. The assembly of claim 14 wherein the support layer has a width at least twice the width of the link belt to which the top layer is attached.

17. The link belt of any of claim 14 claim wherein the top layer has an elongation that is at least 5 times the elongation of the link belt.

18. A link belt comprising:
a series of belt links arranged in superimposed successive overlapping relation, and
an elongated top layer overlying the link belt to provide a generally flat top surface for supporting items to be conveyed, wherein the top layer is fixedly attached to the belt links and has a width that projects laterally away from the belt links to form an overhanging support surface.

19. The link belt of claim 18 wherein the top layer is thermally bonded to the belt links.

20. The link belt of claim 18 wherein the top layer has a width at least twice the width of the link belt to which the support is attached.

21. The link belt of claim 20 wherein the top layer has a width approximately three times the width of the link belt to which the support is attached.

22. The link belt of claim 21 claim wherein the top layer has an elongation that is at least 5 times the elongation of the belt links.

23. The link belt of claim 22 wherein the top layer has an elongation that is at least 10 times the elongation of the belt links.

24. The link belt of claim 23 wherein top layer comprises a unitary elongated element overlying at least 10 belt links.

25. The link belt of claim wherein the top layer extends along at least approximately half the length of the link belt.

26. The link belt of claim 19 wherein a first fastener mechanically fastens a first end of the top layer to the belt links and a second fastener mechanically fastens a second end of the top layer to the belt links.

27. The link belt of claim 26 wherein the top layer is free of fasteners between the first and second fasteners.
